(19) United States
(12) Patent Application Publication
(10) Pub. No.: US 2026/0149169 A1
(43) Pub. Date: May 28, 2026

(54) ELECTRONIC TIMEPIECE AND ELECTRONIC DEVICE

(71) Applicant: CASIO COMPUTER CO., LTD., Tokyo (JP)

(72) Inventors: Takeshi MATSUE, Tokyo (JP); Nobuharu ASO, Tokyo (JP); Kazu HASEGAWA, Tokyo (JP)

(73) Assignee: CASIO COMPUTER CO., LTD., Tokyo (JP)

(21) Appl. No.: 19/377,072

(22) Filed: Nov. 3, 2025

(30) Foreign Application Priority Data
Nov. 22, 2024 (JP) 2024-203591

(51) Int. Cl. H01Q 1/27; G04G 17/04

(52) U.S. Cl. CPC H01Q 1/273; G04G 17/04

(57) ABSTRACT

An electronic timepiece includes, a substrate; an antenna provided on the substrate; a metal plate-shaped member; and a case that includes a metal sidewall facing an end face of the plate-shaped member and that stores the substrate and the plate-shaped member. The plate-shaped member is electrically connected to the side wall of the case. A gap is provided between a portion of the plate-shaped member and the side wall.

### CROSS-REFERENCE TO RELATED APPLICATIONS

This application claims priority and benefit of Japanese Patent Application No. 2024-203591, filed Nov. 22, 2024. The entire specification, claims, and drawings of Japanese Patent Application No. 2024-203591 are incorporated herein by reference.

### BACKGROUND OF THE INVENTION

### Technical Field

The present disclosure relates to an electronic timepiece and an electronic device.

### Description of Related Art

Conventionally, a wristwatch capable of receiving radio waves containing time information, etc., by means of an antenna installed inside a metal case is known (e.g., Japanese Patent Publication No. 2021-89295). In wristwatches, metal dial plates are sometimes used to enhance texture and design. In a case in which a metal dial plate is used in a wristwatch equipped with an antenna, for example, a configuration in which a gap is provided between an outer circumference of the metal dial plate and a metal case to secure a radio wave passing region may be employed.

### SUMMARY OF INVENTION

An electronic timepiece according to the present disclosure is the electronic timepiece including:
a substrate;
an antenna provided on the substrate;
a metal plate-shaped member; and
a case that includes a metal sidewall facing an end face of the plate-shaped member and that stores the substrate and the plate-shaped member,
wherein,
the plate-shaped member is electrically connected to the side wall of the case, and
a gap is provided between a portion of the plate-shaped member and the side wall.

### BRIEF DESCRIPTION OF THE DRAWINGS

FIG. 1 is a diagram showing an outer appearance of an electronic timepiece.

FIG. 2 is a diagram showing a cross-section of the electronic timepiece at line A-A in FIG. 5.

FIG. 3 is a diagram showing a circuit board and a first antenna.

FIG. 4 is a diagram showing a dial plate.

FIG. 5 is a diagram showing a positional relationship of an inner protrusion of a main body case, the dial plate, a conductive member, an insulating member, and the first antenna.

FIG. 6 is a diagram showing an enlarged view of a part of a cross-section of FIG. 2.

FIG. 7 is a diagram showing a cross-section of the electronic timepiece at line B-B in FIG. 5.

FIG. 8 is a diagram showing another example of the dial plate.

### DETAILED DESCRIPTION

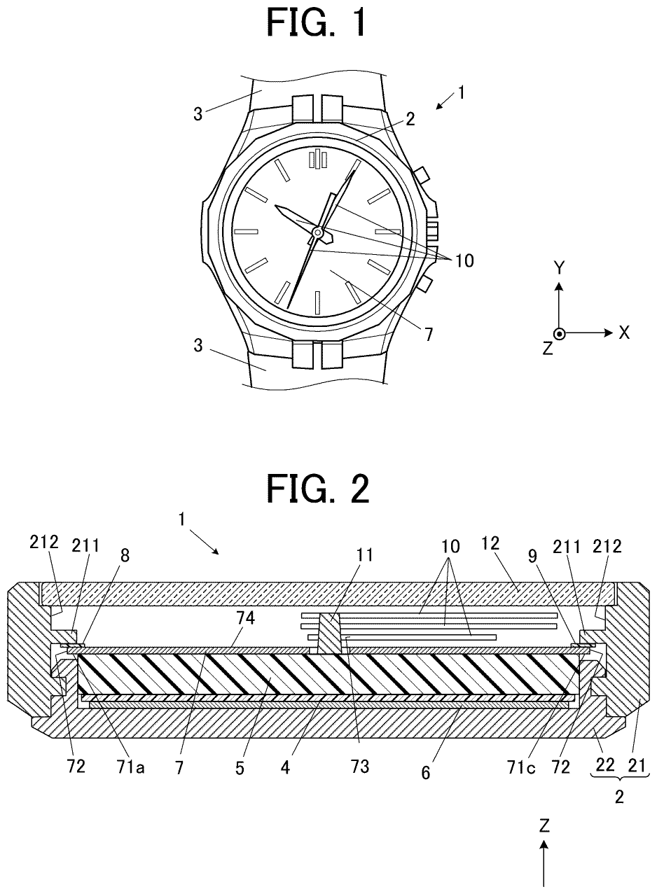

The following is a description of the embodiments of the present disclosure based on the drawings. As shown in FIG. 1, the electronic timepiece 1 includes a case 2 with a dial plate 7 (plate-shaped member) and hands 10, etc. housed inside, and two bands 3 attached to the case 2. The electronic timepiece 1 is a wristwatch that is used in a state worn on a user's wrist by wrapping the band 3 around the wrist. In the following, among directions parallel to a plate surface 74 of the dial plate 7 (see FIG. 2; face on which hour scales are illustrated), a 3 o'clock direction is a +X direction, a 12 o'clock direction is a +Y direction, and a direction which is perpendicular to the plate surface 74 of the dial plate 7 and which heads from a back of the electronic timepiece 1 (face in contact with the wrist when worn) to the surface is a +Z direction (vertical direction). A face of each component that faces the +Z direction is noted as a “top surface” and the face that faces a −Z direction is noted as a “bottom surface”. In the following FIG. 2 to FIG. 8, some parts of the electronic timepiece 1 may be omitted. For convenience of explanation, a size and aspect ratio of each configuration may differ from the original configuration.

As shown in FIG. 2, the case 2 includes a substantial cylindrical interior space and is open at the top, and the top is covered by a transparent disc-shaped windshield glass 12. The case 2 includes a metal main body case 21 (side wall) and a metal back cover 22. The main body case 21 is a substantial cylindrical member that constitutes the side wall of the case 2 and is open at the top and the bottom. The top of the main body case 21 is covered by the windshield glass 12 as described above. An inner protrusion 211 (inner flange) protrudes from an inner wall surface 212 of the main body case 21 toward an interior of the case 2. The inner protrusion 211 is a single connection around the entire circumference of the inner wall surface 212. A top surface and a bottom surface of the inner protrusion 211 are parallel to an XY plane. According to the present embodiment, a bezel surrounding the windshield glass 12 is composed of a portion of the main body case 21. However, the configuration is not limited to this, and the bezel may be a separate component from the main body case 21. The bezel in this case may be metal. The bezel in this case is also a part of the case 2. The back cover 22 is a substantial disc-shaped metal member that seals the bottom of the main body case 21. The back cover 22 may be made of a material including insulating properties, such as resin. The inner space formed by the case 2 and the windshield glass 12 houses a circuit board 4 (substrate), a housing 5, a frame member 6, a dial plate 7, a conductive spacer 8 (conductive member), an insulating spacer 9 (insulating member), a plurality of hands 10 (hour hand, minute hand, and second hand in this embodiment), and a rotary shaft 11.

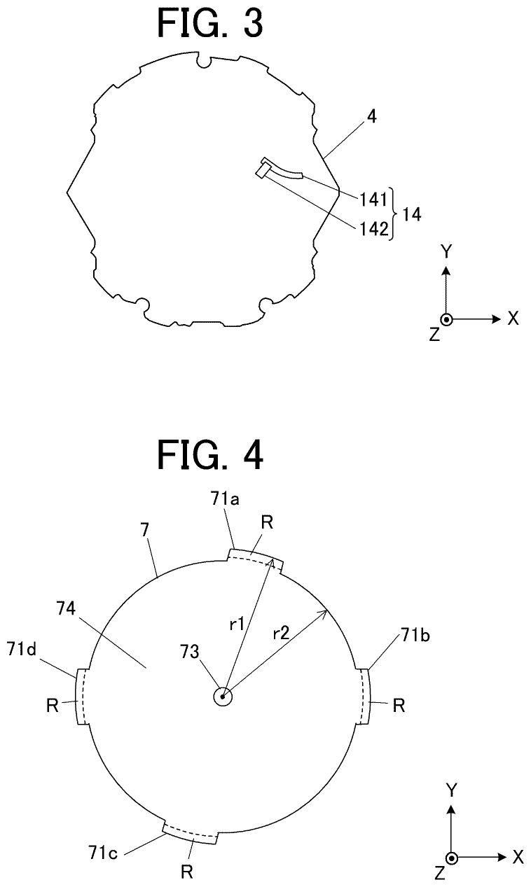

The circuit board 4 is provided with various electronic components and electronic circuits for controlling operations of various parts of the electronic timepiece 1, including the hands 10. A grounding conductor that is at ground potential is formed on a surface of the circuit board 4. The grounding conductor may extend across both the top surface and the bottom surface of the circuit board 4 via a through via that penetrates the circuit board 4. As shown in FIG. 3, a first antenna 14 (antenna) is provided near the periphery of the circuit board 4 for wireless communication with external devices. In FIG. 3, electronic components, electronic circuits, and grounding conductors other than the first antenna 14 are omitted. According to the present embodiment, the wireless communication method is Bluetooth (registered trademark).

The first antenna 14 is designed to be able to transmit and receive wireless radio waves in a frequency band used in Bluetooth, 2.4 GHz to 2.48 GHz. The wavelength of the radio waves in the above frequency band in vacuum is generally 120 to 124 mm, and the quarter wavelength is generally 30 to 31 mm. However, the radio waves inside the case 2 are subject to a wavelength shortening effect depending on relative permittivity of the components (mainly resin) that are housed in the case 2 and through which the radio waves pass. If the wavelength of the radio waves in the above frequency band, taking into account the wavelength shortening effect, is λ, λ/4 is approximately 15 mm in the electronic timepiece 1 according to the present embodiment. The first antenna 14 includes an antenna pattern 141 and an antenna chip 142 connected to the antenna pattern 141. The antenna pattern 141 is a bar-shaped metal conductor provided on the surface of the circuit board 4. The antenna pattern 141 constitutes a grounded monopole antenna using the grounding conductor described above. The antenna chip 142 is, for example, the electronic component to achieve the wavelength shortening effect in the frequency band used. By making the length of the antenna pattern 141 shorter than λ/4 (e.g., about λ/8) and then providing the antenna chip 142 that produces the wavelength shortening effect, it is possible to transmit and receive wireless radio waves in the Bluetooth frequency band. The antenna chip 142 may be omitted when wavelength shortening by the antenna chip 142 is unnecessary. The antenna chip 142 is electrically connected to the grounding conductor via RF matching circuitry or the like, which is not shown in the drawings. The shape of the antenna pattern 141 and the position of the first antenna 14 on the circuit board 4 are not limited to those illustrated in FIG. 3, but can be changed as needed depending on the positional relationship with other components.

As shown in FIG. 2, the housing 5 is located on the +Z direction side of the circuit board 4. The housing 5 is a storage component that contains a drive module (drive mechanism) for rotating a pointer 10, batteries, etc. inside. An outer shape of the housing 5 is a substantial cylinder shape. The housing 5 is made of the resin including insulating properties. The bottom surface of the housing 5, which is in contact with the circuit board 4, is provided with an opening, a cutout, etc. for electrical connection between the drive module and the circuit board 4. The opening is provided on the top surface of the housing 5 for passing the rotary shaft 11. The drive module inside the housing 5 rotates the rotary shaft 11, which in turn rotates the hands 10 attached to the rotary shaft 11.

The frame member 6 holds the circuit board 4 and the housing 5 so that the circuit board 4 and the housing 5 become one piece. The frame member 6 includes a main frame illustrated below the circuit board 4 in FIG. 2, as well as side frames (illustration omitted) that extend in the +Z direction from the ends of the main frame to support the circuit board 4 and the sides of the housing 5. The frame member 6 is made of metal including conductive properties. The frame member 6 includes a plate spring, not shown, that contacts the back cover 22 and is electrically connected to the back cover 22 and the main body case 21. The frame member 6 is electrically connected to the grounding conductor of the circuit board 4. Therefore, the frame member 6, the back cover 22, and the main body case 21 also function as grounding conductors.

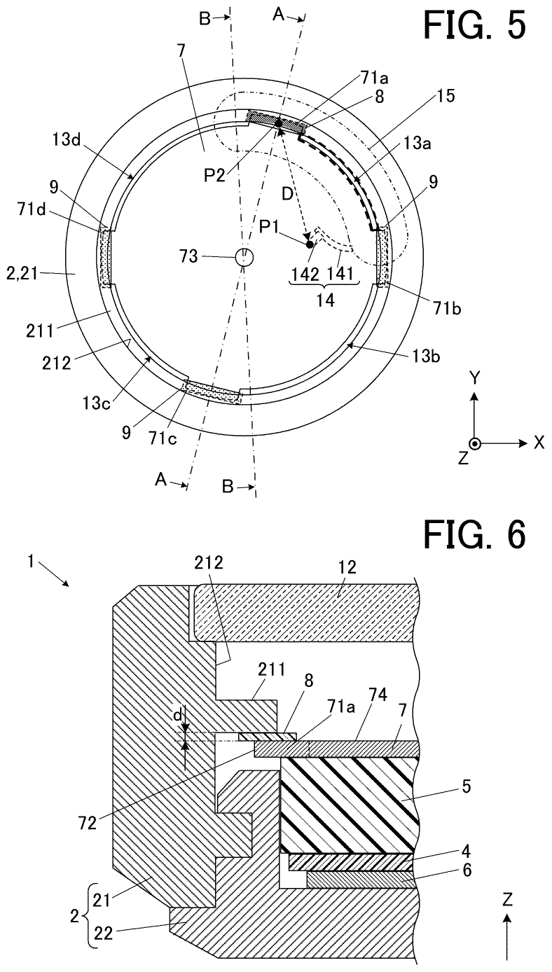

The dial plate 7 is a disk-shaped member located on the +Z direction side of the housing 5. On the plate surface 74 (top surface) of the dial plate 7, the hour scales indicating the position of the hour, minute scales, etc. are provided. According to the present embodiment, the dial plate 7 is metal. The use of the metal dial plate 7 can enhance texture and design of the electronic timepiece 1. In the center of the dial plate 7, a through hole 73 for passing the rotary shaft 11 is provided. An end surface 72 (the side surface connecting the top surface and the bottom surface) of the dial plate 7 faces the inner wall surface 212 of the main body case 21, without contacting the main body case 21. As shown in FIG. 4, the dial plate 7 includes a plurality (four according to the present embodiment) of convex parts 71a to 71d protruding in a direction parallel to the plate surface 74 (direction parallel to the XY plane) at its periphery. In FIG. 4, outline lines of the dial plate 7 are shown, and the hour and the minute scales provided on the plate surface 74 are omitted. Among the four convex parts 71, the convex part 71a and the convex part 71c are provided in a position and region that is point symmetrical with respect to a center of the dial plate 7 (center of the through hole 73) when viewed from the Z direction. The convex part 71b and the convex part 71d are provided in a position and a region that are point symmetrical with respect to the center of the dial plate 7 when viewed from the Z direction. In the following, when referring to any one of the convex parts 71a to 71d, it is referred to as “convex part 71”. The shape of each convex part 71 is, for example, a shape of a fan of a first radius r1 with a fan of a second radius r2 smaller than the first radius r1 removed. A central angle of each fan shape may be, for example, within a range equal to or larger than 10 degrees and equal to or smaller than 45 degrees. Here, the first radius r1 is the length from the center of the dial plate 7 to a tip of the convex part 71, and the second radius r2 is the length from the center of the dial plate 7 to the outline line of the portion of the dial plate 7 where the convex part 71 is not provided. A protrusion amount of the convex part 71 (difference between the first radius r1 and the second radius r2) is within the range where the tip of the convex part 71 does not touch the inner wall surface 212 of the main body case 21. As shown in FIG. 5, each convex part 71 overlaps at least a portion of the inner protrusion 211 when viewed from the Z direction. A region R shown in FIG. 4 represents the region of the convex part 71 that overlaps the inner protrusion 211. The dial plate 7 may be fixed on the housing 5 by regulating the position of each convex part 71. For example, on the top surface of the housing 5, corresponding to each convex part 71, two projections may be provided at positions that sandwich the two side edges of the convex part 71, and the position (movement) of the convex part 71 may be regulated by engaging the convex part 71 with the projections so that the side edge of each convex part 71 is sandwiched between the two projections. Alternatively, the dial plate 7 may be fixed to the top surface of the housing 5 with double-sided tape.

As shown in FIG. 2 and FIG. 6, a conductive spacer 8 is interposed between the convex part 71a of the dial plate 7 and the inner protrusion 211 of the main body case 21. In detail, the conductive spacer 8 is interposed between the portion of the convex part 71a that overlaps the inner protrusion 211 as viewed from the Z direction (portion corresponding to the region R) and the inner protrusion 211. In other words, the conductive spacer 8 is sandwiched between the top surface of the convex part 71a and the bottom surface of the inner protrusion 211. However, as shown in FIG. 5, the conductive spacer 8 may extend outside the portion where the convex part 71a and the inner protrusion 211 overlap as viewed from the Z direction. In FIG. 5, the conductive spacer 8 is marked with a dot to make it easier to see the range to which the conductive spacer 8 extends. According to the present embodiment, the shape of the conductive spacer 8 is rectangular when viewed from the Z direction. The conductive spacer 8 electrically connects the dial plate 7 to the main body case 21 by contacting the dial plate 7 and the main body case 21. As mentioned above, the material of the top surface of the housing 5 on which the dial plate 7 is placed is the resin including insulating properties, so the conductive component in contact with the dial plate 7 is only the conductive spacer 8. Therefore, in a case in which static electricity is generated on the metal dial plate 7, this static electricity flows through the conductive spacer 8 to the main body case 21 and the back cover 22. The conductive spacer 8 may be, for example, an individual piece of copper in which the surface is plated with gold. However, the conductive spacer 8 need only be conductive, and its material is not limited to the above. According to the present embodiment, a thickness d in the Z direction of the conductive spacer 8 shown in FIG. 6 is 0.2 mm. The conductive spacer 8 functions as a spacer that separates the dial plate 7 from the inner protrusion 211 in the −Z direction by the amount of the thickness d of the conductive spacer 8.

As shown in FIG. 2, the insulating spacer 9 is interposed between the convex part 71c of the dial plate 7 and the inner protrusion 211 of the main body case 21. In other words, the insulating spacer 9 is sandwiched between the top surface of the convex part 71c and the bottom surface of the inner protrusion 211. As shown in FIG. 5, the insulating spacers 9 are also respectively placed between the convex part 71b and the inner protrusion 211, and between the convex part 71d and the inner protrusion 211. In other words, the insulating spacers 9 are respectively provided between the convex parts 71b to 71d, which are not provided with the conductive spacers 8 among the four convex parts 71a to 71d, and the inner protrusion 211. As shown in FIG. 5, the insulating spacer 9 may extend outside the portion where the convex parts 71b to 71d and the inner protrusion 211 overlap as viewed from the Z direction. The shape of the insulating spacer 9 viewed from the Z direction may be the same as the shape of the conductive spacer 8. In FIG. 5, the insulating spacer 9 is marked with the dot to make it easier to see the range to which the insulating spacer 9 extends. The material of the insulating spacer 9 is, for example, resin. However, the insulating spacer 9 need only include insulating properties, and the material of the insulating spacer 9 is not limited to resin. The thickness d of the insulating spacer 9 in the Z direction is 0.2 mm. That is, the thickness of the insulating spacer 9 in the Z direction is the same as the thickness of the conductive spacer 8 in the Z direction. The insulating spacer 9, similar to the conductive spacer 8, functions as the spacer that separates the dial plate 7 from the inner protrusion 211 in the −Z direction by the amount of the thickness of the insulating spacer 9. The position and placement region of the conductive spacer 8 provided on the convex part 71a and the position and placement region of the insulating spacer 9 provided on the convex part 71c are point symmetrical with respect to the center of the dial plate 7 when viewed from the Z direction. The position and placement region of the insulating spacer 9 provided on the convex part 71b and the position and placement region of the insulating spacer 9 on the convex part 71d are point symmetrical with respect to the center of the dial plate 7 when viewed from the Z direction.

The dial plate 7 is positioned with respect to the Z-direction by being thrust against the inner protrusion 211 from below in the +Z direction via the conductive spacer 8 and the insulating spacer 9. Therefore, the conductive spacer 8 and the insulating spacer 9 serve as positioning members for the dial plate 7 in the Z direction. By adjusting the thickness of the conductive spacer 8 and the insulating spacer 9, the position of the dial plate 7 in the Z direction can be adjusted.

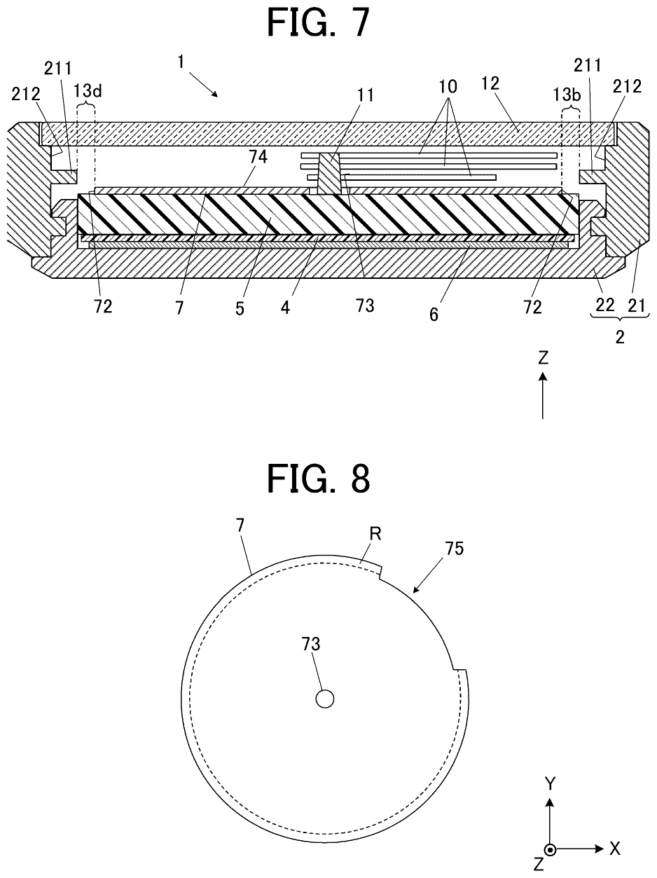

As shown in FIG. 5, as viewed from the Z direction, gaps 13a to 13d are provided between the portion of the dial plate 7 that does not overlap the inner protrusion 211 (the portion from which the convex part 71 does not protrude) and the main body case 21 (inner protrusion 211). Each of the gaps 13a to 13d is provided between two adjacent convex parts 71 among the plurality of convex parts 71a to 71d. The gap 13a is between the convex part 71a and the convex part 71b, the gap 13b is between the convex part 71b and the convex part 71c, the gap 13c is between the convex part 71c and the convex part 71d, and the gap 13d is between the convex part 71d and the convex part 71a. FIG. 7, which shows a cross-section at the line B-B of FIG. 5, shows the gaps 13b and 13d among the above gaps. The radio waves received or transmitted by the first antenna 14 can pass through the gaps 13a to 13d. Although the dial plate 7 and the main body case 21 are metal and thus shield the radio waves transmitted and received by the first antenna 14, by providing the gaps 13a to 13d, the radio waves transmitted and received by the first antenna 14 can pass through. This can prevent a decrease in sensitivity of the wireless communication in the electronic timepiece 1. In the following, when referring to any one of the gaps 13a to 13d, it is referred to as the “gap 13”.

As shown in FIG. 5, a second antenna 15 is formed by portions of the dial plate 7 and the main body case 21 that are adjacent to the gap 13a and the conductive spacer 8 that electrically connects these portions. The second antenna 15 is a slot antenna. In FIG. 5, the range of the gap 13a, which serves as a slot for the slot antenna, is indicated by a thick dashed line. In detail, the second antenna 15 includes as the components a portion of the dial plate 7 adjacent to the gap 13a, a portion of the main body case 21 adjacent to the gap 13, the convex part 71a (first convex part), the convex part 71b (second convex part), and the conductive spacer 8. The grounding conductor of the circuit board 4, the main body case 21 and the back cover 22 also serve as a ground for the second antenna 15. The distance between the convex part 71a and the convex part 71b (the length of the gap 13a, which functions as the slot in the slot antenna) is defined to be a distance at which the radio wave of a predetermined frequency can be received. The predetermined frequency is the frequency of the radio wave transmitted or received by the first antenna 14, and according to the present embodiment, the predetermined frequency is the frequency used in Bluetooth. The distance between the convex part 71a and the convex part 71b may be a length that falls within a predetermined distance range centered on λ/2, for example. The range of the second antenna 15 indicated by the chain line in FIG. 5 represents the approximate range that functions as the second antenna 15 and is not limited to the range of the second antenna 15. At least part of the region indicated by the chain line in FIG. 5 functions as the second antenna 15, and other regions may further function as the second antenna 15. The wireless communication function of the electronic timepiece 1 is realized by the first antenna 14 and the second antenna 15. In detail, some of the radio waves transmitted from the first antenna 14 are received by the second antenna 15 and retransmitted (re-radiated) from the second antenna 15 to the outside of the electronic timepiece 1. The other part of the radio wave transmitted from the first antenna 14 is transmitted (radiated) directly to the outside of the electronic timepiece 1 through the gap 13. Some of the radio waves transmitted from the external device to the electronic timepiece 1 are received by the second antenna 15 and retransmitted from the second antenna 15. This retransmitted radio wave is received by the first antenna 14. The other part of the radio waves transmitted from the external device to the electronic timepiece 1 is received directly by the first antenna 14 through the gap 13.

The point P1 shown in FIG. 5 is a feeding point of the first antenna 14 viewed from the Z direction. The feeding point P1 is the point where a high-frequency current pertaining to the transmitted radio wave flows into the first antenna 14 and the point where the high-frequency current pertaining to the received radio wave flows out from the first antenna 14. The feeding point P1 is actually located on the circuit board 4. The point P2 shown in FIG. 5 is a representative point of an electrical connection position between the dial plate 7 and the main body case 21 (representative connection point P2). In FIG. 5, the representative connection point P2 is an area center of gravity of the region R in which the convex part 71a and the inner protrusion 211 overlap as viewed from the Z direction. However, the representative connection point P2 may be defined at other positions within the region R. In order to enhance a relay function of the radio waves by the second antenna 15, the distance D between the feeding point P1 and the representative connection point P2 should be within a predetermined distance range centered on ¼ of the wavelength of the radio wave transmitted or received by the first antenna 14 (i.e., λ/4 as described above). In other words, among the four convex parts 71a to 71d, it is preferable to electrically connect the dial plate 7 to the main body case 21 by installing the conductive spacer 8 on the convex part 71 such that the distance between the feeding point P1 and the representative connection point P2 is within the predetermined distance range described above. Here, the predetermined distance range may be, for example, λ/4×0.8 or more and λ/4×1.2 or less. More preferably, the predetermined distance range may be, λ/4×0.9 or more and λ/4×1.1 or less.

As described above, the electronic timepiece 1 according to the present embodiment includes the circuit board 4, the first antenna 14 provided on the circuit board 4, the metal dial plate 7, and the case 2. The case 2 includes the metal main body case 21 (side wall) that faces the end surface 72 of the dial plate 7 and houses the circuit board 4 and the dial plate 7. The dial plate 7 is electrically connected to the main body case 21 of the case 2. The gap 13 is provided between a portion of the dial plate 7 and the main body case 21. According to this configuration, in a case in which the static electricity is generated on the metal dial plate 7, this static electricity flows through the conductive spacer 8 to the main body case 21. By defining the path of static electricity transmission in this way, it is possible to prevent large currents due to the static electricity from flowing to, for example, the electronic components on the circuit board 4. In the configuration of the conventional technology, where the metal plate-shaped member that constitutes the dial plate is electrically floating, the path for the static electricity to flow from the metal plate-shaped member to the grounding conductor is indefinite. Therefore, depending on the path for the static electricity, the large current may flow to the electronic components on the circuit board, causing defects such as breakdowns. Therefore, according to the present disclosure, the occurrence of the defects due to the static electricity can be suppressed compared to the configuration of the conventional technology. By providing the gap 13, the radio wave transmitted or received by the first antenna 14 is able to pass through the gap 13, so that the radio wave can be transmitted or received by the first antenna 14 while using the metal dial plate 7. By electrically connecting the dial plate 7 and the main body case 21 and providing the gap 13 between the dial plate 7 and the main body case 21, the portion of the dial plate 7 and the main body case 21 that is adjacent to the gap 13 functions as the second antenna 15 (slot antenna). Therefore, the sensitivity (antenna gain) of the wireless communication can be improved to the extent that the dial plate 7 functions as the second antenna 15, compared to the conventional technology configuration in which the dial plate is simply floating.

The electronic timepiece 1 also includes the conductive spacer 8 that is interposed between the dial plate 7 and the main body case 21 of the case 2 to electrically connect the dial plate 7 and the main body case 21. This allows the conductive spacer 8 to support the dial plate 7 while electrically connecting the dial plate 7 to the main body case 21 by the conductive spacer 8. Therefore, compared to the conventional technology configuration in which the dial plate 7 is free and floating, the position of the dial plate 7 is less likely to be shifted and the shock resistance of the electronic timepiece 1 can be improved. The thickness of the conductive spacer 8 creates the gap 13 between the dial plate 7 and the main body case 21, and with this, the radio wave passes through more easily and the sensitivity of the wireless communication is improved.

The main body case 21 includes the inner protrusion 211 protruding toward the interior of the case 2, and the dial plate 7 partly overlaps the inner protrusion 211 when viewed from the Z direction perpendicular to the plate surface 74 of the dial plate 7. The conductive spacer 8 is interposed between the portion of the dial plate 7 that overlaps the inner protrusion 211 and the inner protrusion 211 with respect to the Z direction. According to this configuration, the dial plate 7 can be positioned with respect to the Z direction by striking the dial plate 7 in the Z direction toward the conductive spacer 8.

The dial plate 7 includes a plurality of convex parts 71 protruding in the direction parallel to the plate surface 74 at the periphery. Each of the plurality of convex parts 71 overlaps at least a portion of the inner protrusion 211 as viewed from the Z direction. The conductive spacer 8 is interposed between some of the plurality of convex parts 71 and the inner protrusion 211. The insulating spacer 9 is interposed between the convex part 71 and the inner protrusion 211 where the conductive spacer 8 is not interposed, among the plurality of convex parts 71. By using the configuration provided with the convex part 71, the gap 13 can be provided between the portion of the dial plate 7 that is not provided with the convex part 71 and the main body case 21. The dial plate 7 can be electrically connected to the main body case 21 via the conductive spacer 8 provided on the convex part 71. According to the configuration provided with the convex part 71, the gap 13a is created in the vicinity of the conductive spacer 8, so that the portion of the dial plate 7 and the main body case 21 adjacent to the gap 13a and the configuration including the conductive spacer 8 can function as the second antenna 15 (slot antenna). The position of the dial plate 7 can be stabilized to improve the shock resistance of the electronic timepiece 1 by having either the conductive spacer 8 or the insulating spacer 9 interposed between each of the plurality of convex parts 71 and the inner protrusion 211.

The thickness d of the conductive spacer 8 in the Z direction is the same as the thickness of the insulating spacer 9 in the Z direction. This allows the conductive spacer 8 and the insulating spacer 9 to position the dial plate 7 in the Z direction.

The gap 13a is provided between the convex part 71a provided with the conductive spacer 8 among the plurality of convex parts 71 and the convex part 71b adjacent to such convex part 71a. The electronic timepiece 1 is provided with the second antenna 15, which is the slot antenna including the portion of the dial plate 7 and the inner protrusion 211 that is adjacent to the gap 13a, the conductive spacer 8, the convex part 71a, and the convex part 71b. This allows the dial plate 7 to function as part of the second antenna 15, thereby improving the sensitivity of the wireless communication compared to the conventional technology configuration in which the dial plate 7 is floating.

The distance between the two convex parts 71a and 71b is the distance at which the second antenna 15 is capable of receiving the radio wave at a predetermined frequency. This allows the second antenna 15 to receive and transmit desired radio waves, such as those used in Bluetooth.

In addition, viewed from the Z direction, the gap 13 is provided between the portion of the dial plate 7 that does not overlap the inner protrusion 211 and the main body case 21. This allows radio waves transmitted or received by the first antenna 14 to pass from one side of the dial plate 7 to the other in the Z direction. Thus, the sensitivity of the wireless communication can be further improved.

The distance D between the feeding point P1 of the first antenna 14 and the representative connection point P2, which is the electrical connection position of the dial plate 7 and the main body case 21, is defined to be the distance corresponding to the wavelength of the radio wave transmitted or received by the first antenna 14. According to the above embodiment, the distance D between the feeding point P1 and the representative connection point P2 is included in a predetermined distance range centered on ¼ of the wavelength of the radio wave transmitted or received by the first antenna 14. This increases the antenna gain of the second antenna 15 and further improves the sensitivity of the wireless communication.

The present disclosure is not limited to the above embodiments, but can be modified in various ways. For example, the number of convex parts 71 is not limited to four. To support the dial plate 7, at least three convex parts 71 should be provided, and five or more may be provided. As shown in FIG. 8, the dial plate 7 may include one recess 75 for configuring the gap 13 as the slot for the second antenna 15 (slot antenna) and not include the convex part 71. In this case, the entire portion of the outer circumference of the dial plate 7, excluding the recess 75, is the region R overlapping the inner protrusion 211. However, even in this case, it is preferable to place the conductive spacer 8 and the insulating spacer 9 at the position that is point symmetrical with respect to the center of the dial plate 7.

The conductive spacer 8 may be omitted, and the dial plate 7 may be electrically connected to the main body case 21 by providing a metal projection on the top surface of some of the plurality of convex parts 71 of the dial plate 7 and bringing the projection into contact with the inner protrusion 211. The insulating spacer 9 can be interposed between the convex part 71 that is not electrically connected to the inner protrusion 211 among the plurality of convex parts 71 and the inner protrusion 211.

The gap 13 between the dial plate 7 and the main body case 21 does not necessarily have to be provided from the Z direction, for example, the gap 13 may be provided from the direction parallel to the XY plane.

The inner protrusion 211 of the main body case 21 need not be connected around the entire circumference. The inner protrusion 211 should protrude at least at the position where the inner protrusion 211 overlaps the convex part 71, and the inner protrusion 211 at the position where the inner protrusion 211 does not overlap the convex part 71 may be omitted.

In addition, the conductive spacer 8 (or the projection as described above, same hereafter in this paragraph) may be provided at two or more convex parts 71, respectively to electrically conduct with the main body case 21. For example, the conductive spacer 8 may be provided in place of the insulating spacer 9 at the location of the convex part 71b in FIG. 5. In this case, a closed path is formed around the gap 13a, consisting of the dial plate 7, the main body case 21, and the two conductive spacers 8. The second antenna 15 of the slot antenna can also be established by this configuration. The conductive spacers 8 may also be provided in three or more of the convex parts 71 or all of the convex parts 71, giving priority to static electricity resistance.

The example of the dial plate 7 as the metal plate-shaped member is not limited to this. For example, part of the dial plate 7 may consist of the metal plate-shaped member. As one example, the dial plate 7 may be composed of a resin dial plate and a metal plate-shaped member in one piece, with the metal plate-shaped member exposed through an opening or a cutout provided in the resin dial plate. The metal plate-shaped member may also be a magnetic resistant plate to suppress the effects of external magnetic fields.

According to the above embodiment, an analog electronic timepiece 1 that displays the time by means of the hands 10 is exemplified, but is not limited to this. The electronic timepiece 1 may be a digital system that displays the time by means of a liquid crystal display or other display device, or it may be a combination model that combines analog and digital systems.

Also, it is of course possible to modify the detailed configuration and operation of each component of the electronic timepiece 1 in the above embodiment to the extent not to depart from the scope of the present disclosure. Although embodiments of the present disclosure have been described, the scope of the present disclosure is not limited to the embodiments described above, but includes the scope of the invention described in the claims and their equivalents.

1. An electronic timepiece comprising:
a substrate;
an antenna provided on the substrate;
a metal plate-shaped member; and
a case that includes a metal sidewall facing an end face of the plate-shaped member and that stores the substrate and the plate-shaped member,
wherein,
the plate-shaped member is electrically connected to the side wall of the case, and
a gap is provided between a portion of the plate-shaped member and the side wall.

2. The electronic timepiece according to claim 1, further comprising a conductive member that is interposed between the plate-shaped member and the side wall of the case and that electrically connects the plate-shaped member and the side wall.

3. The electronic timepiece according to claim 2, wherein,
the sidewall includes an inner protrusion that projects toward an interior of the case,
the plate-shaped member partially overlaps the inner protrusion as viewed from a vertical direction perpendicular to a plate surface of the plate-shaped member, and
the conductive member is interposed between a portion of the plate-shaped member that overlaps the inner protrusion and the inner protrusion with respect to the vertical direction.

4. The electronic timepiece according to claim 3, wherein,
the plate-shaped member includes a plurality of convex parts protruding in a direction parallel to the plate surface at a periphery,
at least a portion of each of the plurality of convex parts overlaps the inner protrusion as viewed from the vertical direction,
the conductive member is interposed between some of the convex parts of the plurality of convex parts and the inner protrusion, and
the insulating member is interposed between the convex part that does not include the intervening conductive member among the plurality of convex parts and the inner protrusion.

5. The electronic timepiece according to claim 4, wherein a thickness of the conductive member in the vertical direction is the same thickness as a thickness of the insulating member in the vertical direction.

6. The electronic timepiece according to claim 4, wherein,
the gap is provided between a first convex part in which the conductive member is provided among the plurality of convex parts and a second convex part adjacent to the first convex part, and
the electronic timepiece further includes a slot antenna that includes a portion of the plate-shaped member and the inner protrusion adjacent to the gap, the conductive member, the first convex part and the second convex part.

7. The electronic timepiece according to claim 6, wherein a distance between the first convex part and the second convex part is the distance at which the slot antenna can receive a radio wave with a predetermined frequency.

8. The electronic timepiece according to claim 3, wherein the gap is provided between the portion of the plate-shaped member not overlapping the inner protrusion as viewed from the vertical direction and the side wall.

9. The electronic timepiece according to claim 1, wherein a distance between a feeding point of the antenna and an electrical connection position of the plate-shaped member and the side wall is determined to be the distance corresponding to a wavelength of the radio wave transmitted or received by the antenna.

10. The electronic timepiece according to claim 9, wherein the distance between the feeding point and the connection position is included in a predetermined distance range centered on ¼ of the wavelength of the radio wave transmitted or received by the antenna.

11. An electronic device comprising:
a substrate;
an antenna provided on the substrate;
a metal plate-shaped member; and
a case that includes a metal sidewall facing an end face of the plate-shaped member and that stores the substrate and the plate-shaped member,
wherein,
the plate-shaped member is electrically connected to the side wall of the case, and
a gap is provided between a portion of the plate-shaped member and the side wall.

12. The electronic device according to claim 11, further comprising a conductive member that is interposed between the plate-shaped member and the side wall of the case and that electrically connects the plate-shaped member and the side wall.

13. The electronic device according to claim 12, wherein,
the sidewall includes an inner protrusion that projects toward an interior of the case,
the plate-shaped member partially overlaps the inner protrusion as viewed from a vertical direction perpendicular to a plate surface of the plate-shaped member, and
the conductive member is interposed between a portion of the plate-shaped member that overlaps the inner protrusion and the inner protrusion with respect to the vertical direction.

14. The electronic device according to claim 13, wherein,
the plate-shaped member includes a plurality of convex parts protruding in a direction parallel to the plate surface at a periphery,
at least a portion of each of the plurality of convex parts overlaps the inner protrusion as viewed from the vertical direction,
the conductive member is interposed between some of the convex parts of the plurality of convex parts and the inner protrusion, and
the insulating member is interposed between the convex part that does not include the intervening conductive member among the plurality of convex parts and the inner protrusion.

15. The electronic device according to claim 14, wherein a thickness of the conductive member in the vertical direction is the same thickness as a thickness of the insulating member in the vertical direction.

16. The electronic device according to claim 14, wherein,
the gap is provided between a first convex part in which the conductive member is provided among the plurality of convex parts and a second convex part adjacent to the first convex part, and
the electronic timepiece further includes a slot antenna that includes a portion of the plate-shaped member and the inner protrusion adjacent to the gap, the conductive member, the first convex part and the second convex part.

17. The electronic device according to claim 16, wherein a distance between the first convex part and the second convex part is the distance at which the slot antenna can receive a radio wave with a predetermined frequency.

18. The electronic device according to claim 13, wherein the gap is provided between the portion of the plate-shaped member not overlapping the inner protrusion as viewed from the vertical direction and the side wall.

19. The electronic device according to claim 11, wherein a distance between a feeding point of the antenna and an electrical connection position of the plate-shaped member and the side wall is determined to be the distance corresponding to a wavelength of the radio wave transmitted or received by the antenna.

20. The electronic device according to claim 19, wherein the distance between the feeding point and the connection position is included in a predetermined distance range centered on ¼ of the wavelength of the radio wave transmitted or received by the antenna.
